(19) United States
(12) Patent Application Publication
(10) Pub. No.: US 2006/0193599 A1
(43) Pub. Date: Aug. 31, 2006

(54) Recording start and stop

(76) Inventor: Paulus Thomas Arnoldus Thijssen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/545,657

(22) PCT Filed: Dec. 3, 2003
(86) PCT No.: PCT/IB03/05723

§ 371 Date: Aug. 15, 2005

(30) Foreign Application Priority Data
Dec. 20, 2002 (EP) .02080520.6

(51) Int. Cl. H04N 9/88

(52) U.S. Cl. 386/83; 386/2

(57) ABSTRACT

The invention concerns a method and device for recording information broadcast over a channel. A receiver (14) receives the information, a recorder (16) records said information, a program timer (18) is programmed with program settings including channel and time settings including start time, and a control unit (22) reads the program settings, makes the receiver tune to the set channel based on said start time if not already tuned thereto, and sets the recorder to start or end recording of the information at a time determined at least partly by other factors than the time settings. The information is preferably a television program and the device preferably a VCR or DVD recorder. The invention provides guaranteed recording of programs even though start or end times programmed into a program timer differs from actual start or end times of the program or tuning to the channel is delayed.

### TECHNICAL FIELD

The present invention is directed towards guaranteeing recording of information, for instance the recording of television programs broadcast over different channels. The invention is more particularly directed towards methods and devices for recording information broadcast over at least one channel.

### BACKGROUND OF THE INVENTION

Recently there have been developed a few number of tools for aiding in recording television programs by for instance using VCRs (Video Cassette Recorder) or DVD (Digital Versatile Disc) recorders. One such tool is the Electronic Program Guide (EPG), where the start and end times of programs of different channels are shown. A certain program to be recorded can then be programmed for recording by simply selecting the program in the Guide. The selected program start and end times together with channel information are then automatically entered into the program timer of the recording device upon acknowledgement of the selection.

Another tool present is VPS/PDC (Video Programming System)/(Program Delivery Control). Here start and end triggers of programs broadcast on a channel are provided together with actual program information. This means that a recording device using VPS/PDC just has to tune to the channel and recording will not start until a start trigger is sent on the channel and then recording will continue until an end trigger is sent on the channel. When a recording device recognizes the trigger, it automatically starts and stops recoding upon reception of the start and end triggers.

This system has a major drawback. This is that a start trigger includes information about the start time. If the programmed start time in a timer of a recording device differs from the start time of the start trigger, no recording will take place. A wrong start time can be programmed into a timer because of a mistake by a user or it can be wrong because of erroneous information being input into an electronic program guide. The start trigger can also be missed by a recorder because tuning to the channel is made after the sending of the start trigger, which can take place when recording is delayed because of a delayed recording of a previous program. The (originally announced) start time is used as identification of VPS/PDC triggers. This means that, whenever the programmed start time differs from the VPS/PDC identification, the trigger will not be recognized as such. As a consequence of this, a programmed start time being earlier or later than the start time of the VPS/PDC trigger leads to the program not being recorded at all.

EP 0 843 469 describes the comparison of VPS data sent on a channel with the programmed starting time of a program timer. If these are not the same, the recorder checks other channels for the starting time. Channels are selected for comparison according to a priority scheme. This document therefore describes a relatively complicated method of checking start times if there is no correspondence between the start trigger and the start time in the timer.

WO 02/47380 describes a hard disc recorder using VPS/PDC, where recording of a televisions program is started at a programmed start time adjusted with an extended time or when a start trigger is received, whichever comes first. Programming is also ended if an end trigger is received or at an end time adjusted with an extended time, whichever comes first. Superfluous information is then deleted afterwards in a finished recording by analyzing the recorded information in an intelligent way.

This guarantees recording of the program. There is however a high probability of superfluous information being recorded. A start trigger might also be received after this safe recording has been started. If another medium than a hard disc is used there might be no possible way to edit the recording afterwards, which is especially the case with VHS. It might therefore be hard to easily find the starting point of the program when replaying the recording. This might lead to long rewind times, which can annoy a user. The analyzing of the recorded information furthermore requires complex and expensive additional software.

VPS/PDC is not always present on all channels. Recording of programs can therefore also be at least partly missed because for instance programs sent on some channels are started earlier than what can be indicated and some programs might be started later than when indicated, either in electronic program guides or in other types of program guides. Programs might also be delayed because of disruptions within the program. This means that for instance the end of a program can be missed, which can be highly annoying if it is for instance the very exciting end of a movie. This can be especially annoying in the case when the programming is done in an automatic fashion using an EPG. Then the EPG will not be the useful tool it was meant to be, since a user has to adjust the recording times manually if the channel have the above mentioned faults.

There is therefore also a need to let a user start or end recording of programs earlier or later than the starting time programmed into a timer.

### SUMMARY OF THE INVENTION

The present invention is therefore directed towards solving the above-mentioned problems associated with guaranteeing recording of programs on a channel having a recording support system such as VPS/PDC even though the start trigger of this recording support system differs from the programmed start time or is missed and at the same time to provide a way to later easily find the actual starting time of the program where a start trigger is received later than when the safe recording has been started without having to rely on analyzing the recorded information.

One object of the present invention is thus to provide a method of guaranteeing recording of broadcast information on a channel having a recording support system such as VPS/PDC even though the start trigger of this recording support system differs from the programmed start time or is missed and also ensures that a recording is started when the program actually starts in case a start trigger is received later.

According to a first aspect of the present invention, this object is achieved by a method of recording information broadcast over at least one channel, comprising the steps of: reading program settings of a program timer, said settings including channel information and time settings at least including a start time, tuning to the channel set in the program timer based on said start time if not already being tuned to the channel, and starting or ending recording of the information at a time determined at least partly by other factors than time settings of the program timer, in order to guarantee recording of the information, wherein the step of starting or ending recording comprises:

if the channel includes start and end triggers in broadcast information,

if there is no start trigger corresponding to the start time of the program timer when tuned to the channel,

directly starting a first recording of the information at the start time of the program timer or at the time of tuning, if this time of tuning is later than the start time of the program timer, and

in case of receiving a start trigger corresponding to the start time of the program timer after the start of the first recording,

ending the first recording, and

starting a second recording upon reception of the start trigger.

Another object of the present invention is to provide a device, which guarantees start of recording of information on a channel having a recording support system such as VPS/PDC even though the start trigger of this recording support system differs from the programmed start time or is missed and also ensures that a recording is started when the program actually starts in case a start trigger is received later.

According to a second aspect of the present invention, this object is achieved by a device for recording information broadcast over at least one channel, comprising: a receiver for receiving information broadcast over said channel, a recorder arranged to record broadcast information, at least one program timer programmable with program settings, said settings including channel information and time settings at least including a start time, and a control unit arranged to read the program settings of the program timer, set the receiver to tune to the channel set in the program timer based on said start time if not already being tuned to the channel, and set the recorder to start or end recording of the information at a time determined at least partly by other factors than time settings of the program timer in order to guarantee recording of the information, wherein the control unit in the process of starting or ending recording is further arranged to:
if the channel includes start and end triggers in broadcast information and if there is no start trigger corresponding to start time of program timer present when the receiver is tuned to the channel, directly set the recorder to start recording the information at the start time of the program timer or at the time of tuning, if this time of tuning is later than the start time of the program timer, and

in case of receiving a start trigger corresponding to the start time of the program timer after the start of the first recording

ending the first recording, and

starting a second recording upon reception of the start trigger.

Claims 2 and 16 ensures that information recorded before start of the program is removed at the time of the second recording, such that valuable space is not occupied.

Claims 3 and 17, ensures that the space occupied by material recorded before start of the program is limited as far as possible, when it is not possible to delete this information at the start of the second recording.

Claims 8 and 19 are directed towards allowing a user change the start and/or end time of a program to be recorded by using an extending timer. This is advantageous when a program is sent too early or is delayed and a user does not have to reprogram a program timer in order to change the start or end times of the recording.

Claim 9 is directed towards using an electronic program guide when programming a program timer. This makes the programming of a program timer simplified. The use of an extending timer is even more advantageous if the program timer is programmed in this automatic way.

Claim 10 is directed to dedicating extending timers to a certain channel. This is advantageous in that all programs recorded on a certain channel is either started earlier than the start time or delayed from the end time of the program timer, without a user having to program a program timer or an extending timer each time a new recording is being made on a certain channel. This is especially applicable if programs are systematically started too early or ended too late on the channel.

Claim 13 is directed to the use of a first and second program timer. The advantage here is that the starting of a second recording is guaranteed even if the ending time of a first recording is extended.

With the present invention recording of information is guaranteed although there is no start trigger corresponding to the start time programmed into a program timer present when tuned to the channel supporting VPS/PDC on which the information is sent. Another advantage is that a user will not have to reprogram a program timer or program a new program timer if information on a channel is started to be sent too early or is being delayed in case the channels does not support VPS/PDC.

The expression “based on a time” is intended to comprise performing an action at said time, at said time adjusted with and extending value or as soon as possible after said time as a previous commitment allows.

The basic idea of the invention is to provide a way of guaranteeing recording of a program on a channel having a recording support system such as VPS/PDC even though the start trigger is not received properly and to provide a new recording in case the start trigger is received late.

The above mentioned and other aspects of the invention will be apparent from and elucidated with reference to the embodiments described hereinafter.

### BRIEF DESCRIPTION OF THE DRAWINGS

The present invention will be further described in relation to the accompanying drawings, in which:

FIG. 1 shows a block schematic of a device according to the present invention,

FIG. 2 shows a flow chart of a first part of a method of recording according to the present invention, and

FIG. 3 shows a flow chart of a second part of the method according to the invention.

### DETAILED DESCRIPTION OF THE INVENTION

The present invention is generally directed towards the recording of information broadcast over at least one channel. Such broadcasts is in the preferred embodiment of the invention television programs broadcast on television channels, which can be normal airborne channels as well as satellite channels or cable TV channels or perhaps web TV channels. It is however possible that the broadcasting channels can be different type of radio channels as well, such as web radio channels or radio channels sent via air, satellite or cable. The broadcast information can thus be programs, television or radio as well as separate pieces of programs such as a video or pieces of music. The preferred embodiment of the present invention is therefore a video cassette recorder (VCR). However the invention can also be used in Digital Versatile Disc (DVD) recorders or a hard-disc recorder or other types of recorders for just recording sound.

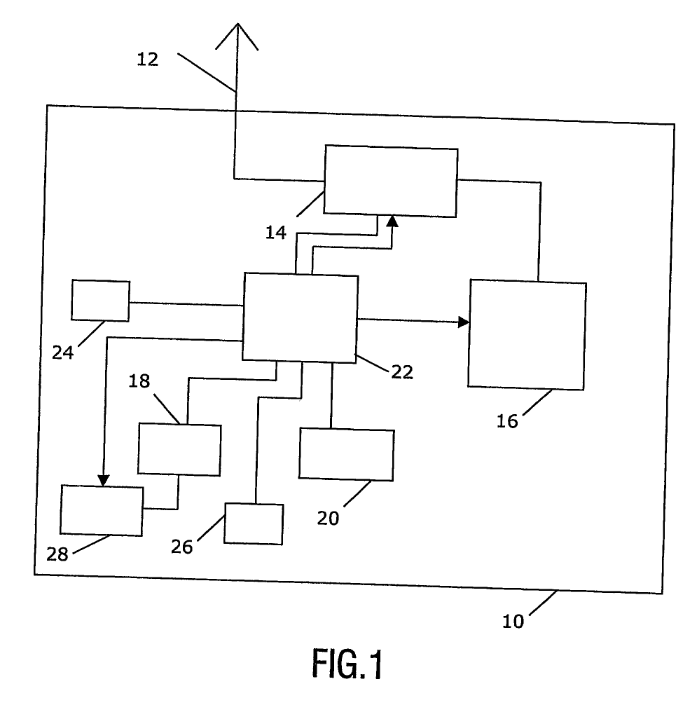

FIG. 1 shows a block schematic of a device according to the invention in the form of a VCR 10. The VCR 10 is connected to an antenna 12, which can receive information in the form of television programs broadcast by different television network operators. The antenna can be provided as a part of the VCR or as a separate entity to which the VCR 10 is connected. As television programs can be transmitted by other means than via the air, the VCR 10 does not have to be connected to an antenna 12, but can be connected to a satellite dish either directly or via a satellite receiver or to a cable of a cable supplier. The antenna 12 is connected to a receiver 14 within the VCR 10, which can be set to tune to different transmission frequencies. The receiver 14 is connected to a recorder 16, which can record the programs on the frequency to which the receiver 14 is tuned. The VCR 10 furthermore includes a control unit 22 controlling the recorder 16 and the receiver 14 and also being connected to the receiver 14. According to the invention there is also provided a first program timer 18 and a second program timer 20, each connected to the control unit 22. There are furthermore provided a first extending timer 26 and a second extending timer 24 both connected to the control unit 22. In the VCR there is furthermore provided an Electronic Program Guide (EPG) 28 connected to the first and second program timers 18 and 20. The control unit 22 controls the EPG 28, which control is indicated by an arrow pointing to the EPG 28 from the control unit 22.

It should be realized that the content of the EPG 28 can be downloaded from a broadcasting operator under control of the control unit for instance through reading teletext pages.

Operation of the device will now be described. The receiver 14 can be tuned to several different channels all broadcasting information in the form of programs. A user of the VCR 10 can program a program timer for recording a program on any channel receivable via the receiver 14. When doing this the user can manually program the first program timer 18 with settings about a first program to be recorded, where this information includes information about which channel is to be recorded, the start time of the recording and the end time of the recording. He can also program the second program timer 20 for recording a later broadcast program, which is perhaps broadcast on a different channel. As an alternative to manual entry of this information into the first timer, the user can program the timer via the EPG 28. The information of channel, start time and end time is then present in the EPG 28 and this information is transferred from the EPG to the first program timer 18 under the control of the control unit 22. All the user really has to do in this case is to select program in the EPG and confirm the selection; Other alternatives of programming a timer are to transfer this information from teletext pages received via a channel.

Many channels support VPS/PDC, which is a system where start and end triggers for programs are sent on a channel. A start trigger then includes the originally announced start time of a program and recording can be automatically started when this start trigger is encountered. There is however a problem with this approach. This is that if the programmed start time of the program timer is somehow wrong, being either later than the time indicated in the start trigger or earlier than the time indicated in the start trigger, the trigger will be ignored. The result is that the program is not recorded at all, which is a serious drawback. The start time in the program timer can furthermore be correct and programming can still be missed. In this case, the user might be busy recording another program on another channel at the programmed start time and the receiver will tune to the channel to be recorded after the start time of the program timer. If a start trigger was present on the channel before the tuning thereto, it is consequently missed and no recording takes place.

A lot of channels do not support VPS/PDC. In these cases some channels might constantly be airing programs too late or too early. When using an electronic program guide for programming a timer, this means that parts of a program might be missed, either at the beginning of the program or at the end of the program. As a consequence an introductory part of a program, that might be vital for understanding it, might be missed. Another possibly worse consequence is that the end of a program might be missed. Programs might furthermore be delayed because of delays in the program. A user might then want to continue recording after the end time set in the program timer without having to stop recording the program and make a new recording.

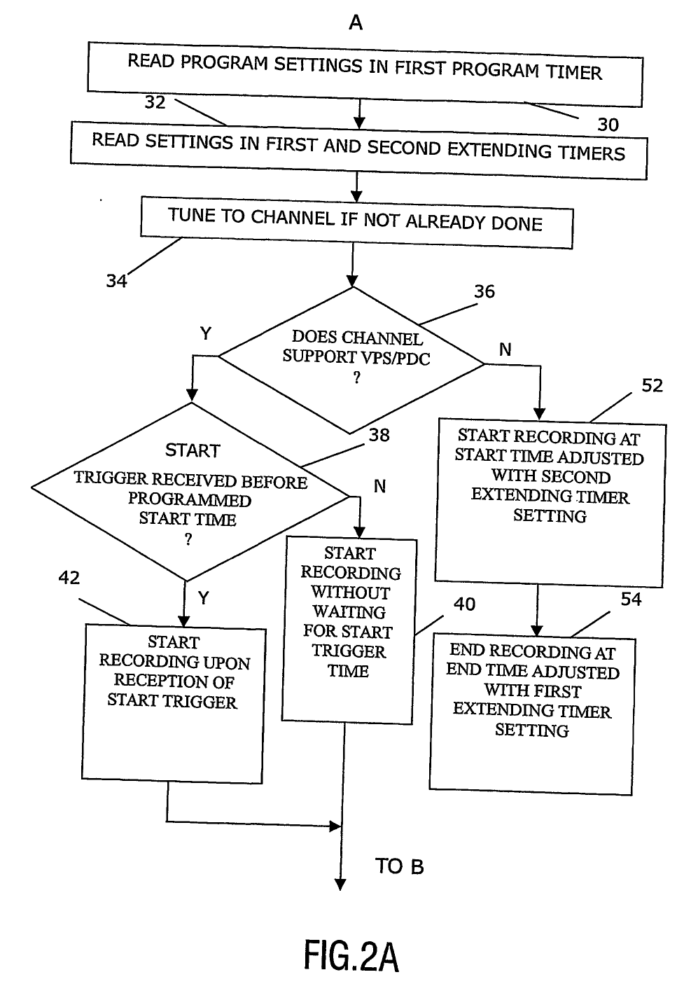

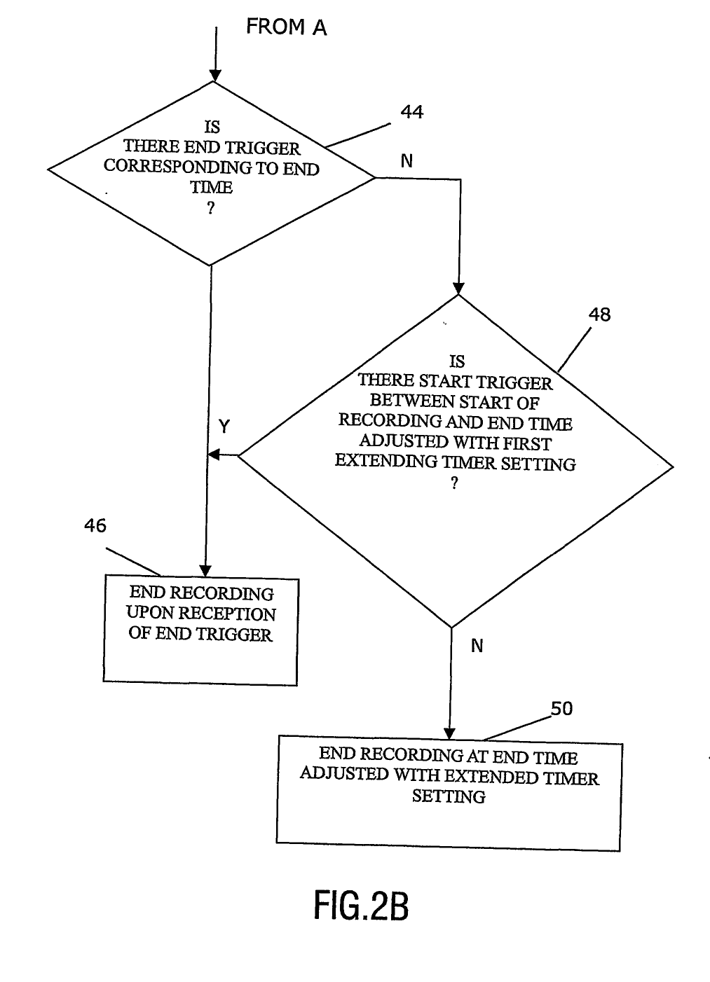

How the present invention solves the above mentioned problems will now be explained, with reference to FIG. 2, which shows a flow chart of a method of recording information according to the invention. The first extending timer 26 may be programmed with a setting or time with which the end time at recording of a program is to be delayed, while the second extending timer 24 may be programmed with a setting or time advancing the start time at recording a program when recording of a program is to take place. The control unit 22 reads the program settings in the first program timer 18 including channel information and start and end times, step 30. It then reads the settings in the first and second extending timers 26 and 24 if there are any, step 32. Thereafter the control unit 22 makes the receiver 14 tune to the channel indicated in the first program timer 18 if it was not already tuned to it, step 34. The tuning can be done at the start time programmed into the first program timer 18, but can be at a time adjusted by the setting in the second extending timer 24 if this adjusted time is earlier than the start time of the first program timer 18. It can also be later than that in case a previous recording on another channel has not been finished at the start time. In this latter case tuning is done immediately after the recording is finished. It can furthermore be earlier than the programmed start time. In channels supporting VPS/PDC, the device has to scan the channel during a scanning period ranging from some time before the programmed start time to some time after the programmed start time. After this the control unit 22 checks if the channel supports VPS/PDC by monitoring the channel, step 36. If the channel does support VPS/PDC, the control unit 22 then monitors the information in the form of triggers sent on the channel via the receiver 14. Thereafter the control unit 22 compares the start time with start triggers sent on the channel, step 38. If no start trigger corresponding to the start time of the first program timer 18 has been received before the programmed start time, step 38, then the control unit 22 sets the recorder 16 to directly start recording without waiting for a start trigger, step 40, which either is at the start time of the first program timer 18 or at the time at which the receiver 14 is tuned to the channel if this time of tuning is later than the programmed start time. There are two instances where there might be no correspondence. Either the start time of the first program timer 18 is different than the start time included in the start trigger, perhaps because of a wrong entering of start time in the first program timer 18 and then there will be no correct start trigger appearing which the VPS/PDC system will accept, or the start trigger has already been sent before tuning to the channel, in which case no start trigger will be received. In the latter case this might be due to the receiver 14 tuning to the channel later than the start time because of a previous recording, which extends beyond the start time of the program. The recorder then keeps on recording the program until it reaches the end of the program. If an end trigger is received then, step 44, recording is ended upon the reception of the end trigger, step 46. If no end trigger is received, step 44, a further check is made if a start trigger has been received between start of the recording and the end time of the first program timer 18 possibly adjusted with the setting of the first extending timer 26, step 48. The adjustment is only considered if the setting of the first extending timer is delaying end of recording in relation to the end time of the first program timer 18. Was such a start trigger received, step 48, recording is ended upon reception of the end trigger, step 46. If no such start trigger was received, step 48, recording is stopped at the end time of the first program timer 18 adjusted by the setting of the first extending timer 26 if this adjusted time delays the end of recording and otherwise at the end time of the first program timer, step 50. If however the start trigger corresponds to the start time of the first program timer 18, step 38, the control unit 22 makes the recorder 16 start recording upon reception of the start trigger, step 42, and the control unit 22 makes the recorder 16 end recording according to the already described steps 44-50.

In case the channel does not support VPS/PDC, step 36, the control unit 22 controls the recorder 16 to start recording at a time which is equal to the start time adjusted with the second extending timer 24 setting if there was one, step 52, and then makes the recorder 16 end recording at a time equal to the end time of the first program timer 18 adjusted with the first extending timer 26 setting if there was one, step 54.

It should here be noted that the first extending timer 26 can either delay end of recording with the made setting or end the recording before the end time in the first program timer 18 by a time decided by the setting. In the same fashion, the second extending timer 24 can either start recording before the start time in the first program timer 18 by a time decided by the setting or delay start of recording with the made setting.

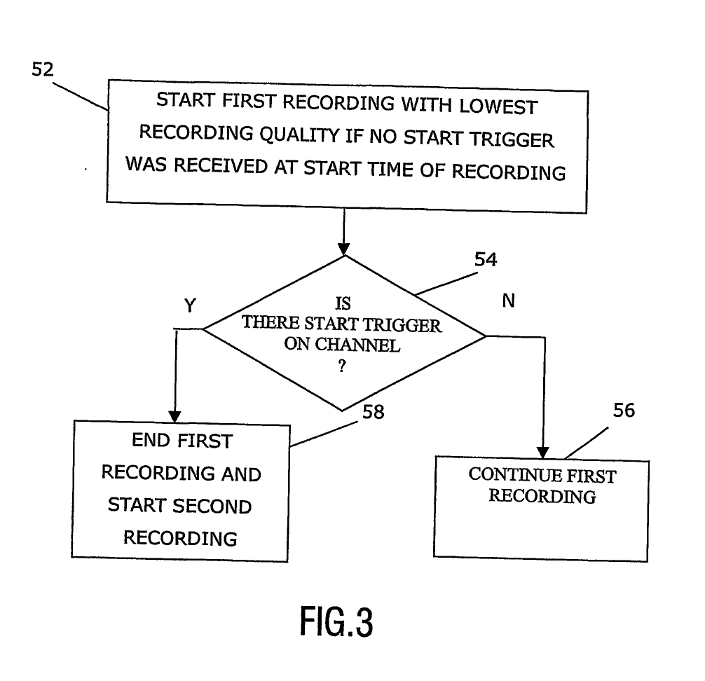

A further variation of the invention will be explained in relation to FIG. 3, which shows a flow chart of another part of the present invention. When the channel supports VPS/PDC and recording has been started directly because no start trigger was received, step 52, the control unit would continue monitoring the channel. If then the start trigger is actually received after this first recording has started, step 54, the control unit makes the recorder stop the first recording and start a second recording upon the reception of the start trigger, step 58. If no such start trigger was received, step 54, the first recording is continued as described before, step 56. The first recording is then a backup recording, which can be deleted when the second recording is started. Deleting the backup recording is a simple task for DVD recorders and HDD recorders. However, for a VCR this may not be feasible due to rewind time. Therefore the first backup recording can be chosen to be made with the lowest recording quality in order to save space. This guarantees that the back-up recording takes up as little space as possible. By starting a new recording it is furthermore easy to find the actual starting position of the program on the medium on which it is stored. If the device according to the invention is equipped with a tape manager, the backup recording can be marked as such, which makes it even easier to differentiate between the actual recording and the backup recording. The backup recording can then easily and safely be removed.

An extending timer can be associated with a certain channel, because some channels might always be a bit delayed and some might always be a bit early. In that case a pair of first and second extending timers may be provided for one channel. There may thus be provided several such extending timers for several channels. This facilitates programming of timers in a very convenient way for a user. Then he only has to supply information about prerecording or delay for a channel once, which will then be applied to all programs to be recorded on that channel by the control unit 22. He can therefore safely program the program timer via for example the EPG 28, without having to worry about the incorrect starting times. It is furthermore normally not necessary to have more than one extending timer per channel, where the timer is either one that advances recording or one that delays recording. Each extending timer for a channel can therefore receive it's own setting. It is however preferred to provide two extending timer for a channel, one that adjusts the start time and one that adjusts the end time.

Yet another possible variation of the present invention is that a second program timer has been programmed with a starting time of a second program to be recorded or a starting time adjusted with a setting in the second extending timer, which is before the ending time of a first program timer or the ending time adjusted with a setting in the first extending timer. Then a prioritizing scheme is applied in order to safeguard that at least not too much information is lost.

The control unit compares these two adjusted start and end times and starts and ends recording according to the following schemes:

In a first step it eliminates as much as is needed of the advance time of the second extending timer applied to the second program timer. If this is not enough for avoiding overlapping of start and end times, the control unit performs a second step, where it eliminates as much as is needed of the delay time of the first extending timer applied to the first program timer. If there is still an overlapping of start and end times, the control unit performs a third step, where it does not start recording the second program until the first program has ended recording.

This can be varied in some ways. In the third step the opposite priority could be made in that the control unit ends recording of the first program when the new start time of the second program has been reached. The second step could as an alternative also be omitted completely.

The present invention therefore has the following advantages. It allows recording on channels supporting VPS/PDC even though no start trigger corresponding to the set start time in the program timer is received or even though the start trigger has been missed completely. The present invention also allows earlier start or delayed ending of recording of programs for channels not supporting VPS/PDC, in which case extending timers are programmed with settings advancing recording or delaying ending of recording of programs. For programs that are delayed this means that the user just extends the programming and does not have to make a new programming if the original was too short. The invention furthermore makes it easy to find the actual starting position of a program on the medium on which it is stored when a back-up recording has been made. The back-up recording also takes up as little space as possible or no space.

The present invention can be varied in many ways. For instance there might be provided more program timers than the two shown in FIG. 1 for allowing programming of several programs. There might also be more extending timers for taking care of delays and/or early sending of programs in different channels. These extending timers can furthermore be provided for different channels such that systematic delays or early starts are automatically taken care of, when programming is taking place via for instance an EPG. The device does also not have to include an EPG. Consequently the present invention is only to be limited by the following claims.

The invention concerns a method and device for recording information broadcast over a channel. A receiver (14) receives the information, a recorder (16) records said information, a program timer (18) is programmed with program settings including channel and time settings including start time, and a control unit (22) reads the program settings, makes the receiver tune to the set channel based on said start time if not already tuned thereto, and sets the recorder to start or end recording of the information at a time determined at least partly by other factors than the time settings. The information is preferably a television program and the device preferably a VCR or DVD recorder. The invention provides guaranteed recording of programs even though start or end times programmed into a program timer differs from actual start or end times of the program or tuning to the channel is delayed.

1. Method of recording information broadcast over at least one channel, comprising the steps of:
reading program settings of a program timer, said settings including channel information and time settings at least including a start time, (step 30),
tuning to the channel set in the program timer based on said start time if not already being tuned to the channel, (step 34), and
starting or ending recording of the information at a time determined at least partly by other factors than time settings of the program timer, in order to guarantee recording of the information (steps 40, 42, 46, 50, 52, 54),
wherein the step of starting or ending recording comprises:
if the channel includes start and end triggers in broadcast information, (step 36),
if there is no start trigger corresponding to the start time of the program timer when tuned to the channel, (step 38),
directly starting a first recording of the information at the start time of the program timer or at the time of tuning, if this time of tuning is later than the start time of the program timer, (step 40), and
in case of receiving a start trigger corresponding to the start time of the program timer after the start of the first recording
ending the first recording, and
starting a second recording upon reception of the start trigger.

2. Method according to claim 1, wherein the step of ending the first recording after receiving a start trigger corresponding to the start time of the program timer after the start of the first recording comprises the step of deleting the first recording.

3. Method according to claim 1, wherein the step of starting the first recording corresponding to the start time of the program timer if no start trigger is received is performed using a lowest recording quality.

4. Method according to claim 1, further including the step of starting recording the information upon receipt of the start trigger (step 40) if there is a start trigger corresponding to the start time of the program timer when tuned to the channel, (step 38).

5. Method according to claim 1, wherein the program settings include an end time and further including the step of: reading a setting of at least one first extending timer (step 32).

6. Method according to claim 5, wherein the step of starting or ending recording comprises:
in the case of the channel including start and end triggers in broadcast information, (step 36), and if there is no end trigger corresponding to the end time of the program timer present on the channel up until the end time of the program timer possibly adjusted with an extended timer setting, (step 44), performing the further steps of:
if there was no start trigger received between start of recording and the end time possibly adjusted with an extending timer setting, (step 48)
ending recording the information at the end time possibly adjusted with the extending timer setting, (step 50), and otherwise
ending recording upon receipt of the end trigger, (step 46).

7. Method according to claim 6, wherein the step of starting or ending recording furthermore comprises:
if the channel includes start and end triggers in broadcast information, (step 36),
and if there is an end trigger corresponding to the end time of the program timer present on the channel up until the end time of the program timer possibly adjusted with the extending timer setting, (step 44), ending recording upon receipt of the end trigger, (step 46).

8. Method according to claim 5, wherein the step of starting or ending recording comprises:
if the channel does not include start and end triggers in broadcast information, (step 36),
starting recording based on said start time, (step 52),
ending recording based on said end time (step 54), and
applying said extended timer setting on either the end time or the start time of the program timer (steps 52, 54).

9. Method according to claim 8, further including the step of programming the first program timer from an electronic program guide.

10. Method according to claim 8, wherein the extending timer is associated with a certain channel and further including the step of applying the extending timer setting on the recording of all programs on said channel recorded via a program timer.

11. Method according to claim 8, wherein the step of applying the extended timer setting includes applying a first extending timer setting for adjusting the end time of a program timer.

12. Method according to claim 11, wherein the step of applying the extended timer setting includes applying a second extending timer setting for adjusting the start time of a program timer.

13. Method according to claim 12, further including the steps of reading the program settings of a second program timer and in case the start time of the second program timer adjusted with a possible second extending timer setting is earlier than the end time of the first program timer adjusted with a possible first extending timer setting, performing the further steps of:
until the start time of the second program is later than the end time of the first program:
removing at least parts of the adjustment of the second extending timer, and
not starting recording earlier than the end time of the first program timer.

14. Method according to claim 13, further including the step of removing at least parts of the adjustment of the first extending timer after removing the adjustment of the second extending timer.

15. Device for recording information broadcast over at least one channel, comprising:
a receiver for receiving information broadcast over said channel,
a recorder arranged to record broadcast information,
at least one program timer programmable with program settings, said settings including channel information and time settings at least including a start time, and
a control unit arranged to
read the program settings of the program timer,
set the receiver to tune to the channel set in the program timer based on said start time if not already being tuned to said channel, and
set the recorder to start or end recording of the information at a time determined at least partly by other factors than time settings of the program timer in order to guarantee recording of the information, and
in the process of starting or ending recording
if the channel includes start and end triggers in broadcast information and if there is no start trigger corresponding to start time of program timer present when the receiver is tuned to the channel, directly set the recorder to start recording the information at the start time of the program timer or at the time of tuning, if this time of tuning is later than the start time of the program timer, and
in case of receiving a start trigger corresponding to the start time of the program timer after the start of the first recording
ending the first recording, and
starting a second recording upon reception of the start trigger.
